(19) United States
(12) Patent Application Publication
(10) Pub. No.: US 2012/0232746 A1
(43) Pub. Date: Sep. 13, 2012

(54) SAFETY SYSTEM FOR AN AIRCRAFT

(75) Inventor: Kurt O. Wiederwohl, Graz (AT)

(73) Assignee: BDP SICHERHEITSTECHNOLOGIEN GMBH, Graz (AT)

(21) Appl. No.: 13/513,193

(22) PCT Filed: Dec. 2, 2010
(86) PCT No.: PCT/EP2010/068734

§ 371 Date: May 31, 2012

(30) Foreign Application Priority Data
Dec. 2, 2009 (AT) A 1910/2009
Dec. 2, 2009 (AT) A 1911/2009

(51) Int. Cl. G07C 5/08; B64D 45/00; B64D 25/00

(52) U.S. Cl. 701/33.4

(57) ABSTRACT

In a safety system (S) for an aircraft (1) for storing flight (FD) and voice data (SD) relevant for reconstructing crashes, comprising a data collection device (6) which is connected to sensors (4, 5) of the aircraft (1) and by means of which relevant flight data (FD) and voice data (SD) of the aircraft (1) can be collected and stored by means of a black box-terra (7) which is substantially inseparably attached to the aircraft (1), the black box-terra (7) being accommodated in an impact-proof and fireproof housing, a data splitter (9, 15) is provided by means of which the flight (FD) and voice data (SD) to be stored in the black box-terra (7) can be delivered in parallel to a black box-water (8; 8.1 to 8.9), and it is furthermore provided that the black box-water (8; 8.1 to 8.9) is likewise designed for storing the collected flight (FD) and voice data (SD), wherein the black box-water (8; 8.1 to 8.9) comprises a floating body or is designed to be self-floating and is designed to emit an alarm signal locatable by a satellite, immediately before, during or after a crash of the aircraft, after having been separated from the aircraft (1) and upon an automatic or manual activation.

The invention relates to a safety system for an aircraft, the safety system for storing flight and voice data relevant for reconstructing crashes being designed with a data collection device which is connected to sensors of the aircraft and by means of which relevant flight data and voice data of the aircraft can be collected and stored by means of a black box-terra which is substantially inseparably attached to the aircraft, the black box-terra being accommodated in an impact-proof and fireproof housing.

Such a safety system for aircraft, such as, e.g., airplanes, is generally known as a so-called black box. In flight, data relevant for the flight, such as, e.g., the air speed, the adjustment of landing flaps, discussions in the cockpit and much more, are collected by the data collection device and stored in the black box-terra working self-sufficiently and/or independently. The black box-terra has an impact-proof and fireproof housing and, after a crash, emits an alarm signal after having been activated by the crash. Rescue teams know the frequency at which said alarm signal is emitted and try to locate the black box-terra with the help of the alarm signal in order to analyze data stored in the black box-terra for reconstructing the reasons for the aircraft's crash.

Because of its impact-proof and fireproof housing, the black box-terra is designed particularly for crashes of the airplane over land. In addition, the housing of the black box-terra is waterproof and withstands even enormous external pressures which prevail in great depths under the water surface. However, in the past, it has frequently become apparent that, in case of crashes over the sea, the black box-terra fixedly connected to the fuselage will sink together with the fuselage to such depths that locating the black box-terra is virtually impossible.

A fairly new model of a black box-terra has even been equipped with a sonar-signal transmitter so that the black box-terra can emit sonar signals under water for the retrieval of the black box-terra. Using submarines, it is attempted to locate these sonar signals and ultimately the black box-terra. But also with this new model of a black box-terra, it has turned out to be a disadvantage that locating the black box-terra at very deep points in the ocean is virtually impossible.

It is now the object of the invention to provide a safety system for airplanes in which the above-indicated disadvantages are avoided. The invention solves this problem in that a data splitter is provided by means of which the flight and voice data to be stored in the black box-terra can be delivered in parallel to a black box-water and in that the black box-water is likewise designed for storing the collected flight and voice data, wherein the black box-water comprises a floating body or is designed to be self-floating and is designed to emit an alarm signal locatable by a satellite, immediately before, during or after a plane crash, after having been separated from the airplane and upon an automatic or manual activation.

In this way, the advantage is obtained that two self-sufficient black boxes which are independent of each other and have different characteristics are present in the airplane. Both black boxes store the same flight and voice data relevant for reconstructing the plane crash. Thus, it is possible in all probability to locate the black box having optimum characteristics depending on the crash site.

Immediately before, during or after the plane crash, detachment means push the black box-water from the fuselage into the water either manually upon activation by the aircrew or automatically. The black box-water possesses a floating body which keeps the black box-water on the water surface, resulting in considerably better transmitting and receiving conditions for the black box-water than for the black box-terra, which possibly is located deep under water. Alternatively, the housing of the black box-water can also be designed to be self-floating and can have enough buoyancy for keeping the black box-water on the water surface. By separating the black box-water from the fuselage, the black box-water is saved from damage which might occur during the sinking of the fuselage or as a result of the collision of the fuselage with the bottom of the sea. Therefore, the chances of locating the black box-water are considerably better than those of finding the black box-terra which has sunk together with the fuselage into the depths of the sea.

By storing the relevant flight data in several black boxes of the aircraft, the advantage is obtained that these black boxes are now detached from the aircraft all at the same time or with different time delays or at different times in each case depending on the existence of one or several of the detachment criteria. Thus, for example, a black box detached only a few seconds before the impact of the aircraft on the ground can survive the crash without any substantial damage, whereas a black box detached or to be detached during or shortly after the crash will be completely destroyed by the crash or an explosion of the fuselage caused thereby. On the other hand, it may happen that a detachment of the black box is effected at an earlier point in time during the crash at an air speed or an altitude which is too high or just during an uncontrolled flight manoeuvre, as a result of which the black box can also be destroyed. Therefore, it is very advantageous to provide several black boxes which are detached from the aircraft at different points in time and optionally depending on the existence of different detachment criteria. The different detachment criteria are discussed in further detail on the basis of the exemplary embodiments.

The black box-terra currently used in airplanes is expensive, heavy and susceptible to repairs and may, in future, be replaced in new airplane designs by detachable or ejectable black boxes the number of which is determined depending on the type, size and use of the respective aircraft. The black boxes according to the invention are designed for crashes both into the water and over land and might thus be produced cost-efficiently in very large quantities.

It may happen that individual areas of the airplane are damaged particularly badly during the crash of the airplane. In order to increase the chance that at least one of the two black boxes will survive the crash without any substantial damage, the black boxes are attached in and on the fuselage, respectively, in different positions. The different designs of the two black boxes and their different characteristics, respectively, ensure additional data integrity. Advantageously, the relevant data can be read entirely from one of the two black boxes, since both black boxes store the entire relevant data.

It has turned out to be advantageous to provide the black box-water in a cavity of the fuselage and in particular in a cavity on the upper side of the fuselage. Since, during ditchings, the upper side of the fuselage suffers least damage, such a black box-water can be detached or decoupled from the fuselage immediately before, during or after the ditching and falls from there into the water and floats. Even if the fuselage sinks into the sea afterwards, the black box-water can be located and retrieved comparatively easily on the basis of its alarm signal.

It is particularly advantageous to blast or shoot the black box-water from the fuselage, thus making sure that the black box-water will float in the water after having been detached from the fuselage reliably and as quickly as possible. Should the fuselage explode immediately after the crash, the black box-water is already at a certain distance and has a better chance of not suffering any damage. Shooting off may be effected by a prestressed spring, by a pressurized pneumatic cylinder or by a pressurized hydraulic cylinder. In case of a fuselage sinking into the water, an underwater pressure release can detach the black box-water from the fuselage after a crash for example in a water depth of 25 metres. However, it may also be advantageous to detach the black box-water already at a low depth of 1.5 m or 5 m in order to make sure that a crashed airplane which has sunk only to a low water depth can also be found reliably.

Furthermore, it is advantageous to provide a mechanical lock of the black box-water which can be actuated manually by a service technician for service operations or by the aircrew immediately before, during or after a plane crash in order to separate the black box-water from the fuselage.

The black box-water has a separate GPS receiver which determines the current GPS position data and transmits them as an alarm signal to a satellite and from there to rescue teams. The alarm signal can also be transmitted and received by rescue teams in a directly terrestrial manner. For this purpose, the alarm signal is transmitted via different frequencies and transmission standards.

Furthermore, it is advantageous to use frequencies of existing emergency-call systems of, for example, 406 MHz for distress signals via satellites, since, in this way, it is possible to resort to existing infrastructure and existing authorizations of frequency ranges.

In shipping, a so-called EPIRB safety system for ships is used, wherein an EPIRB buoy is released by the ship, which buoy starts to transmit the alarm signal upon contact with water. It is now particularly advantageous to adequately adjust such an EPIRB buoy for being integrated in an airplane fuselage and to use it as a black box-water after it has been provided with an impact-proof housing. In this way, it is possible to resort to the entire infrastructure of satellites and receiving stations at sea rescue points which exists for the EPIRB safety system.

Furthermore, it is particularly advantageous if the alarm signal is transmitted with the position data and the identification of the aircraft beginning with the time of the first contact with water, since, as a result of this, rescue teams will immediately know the time of the crash into the water. The position data of the black box-water at the time of the first contact with water, the position data determined since that point in time (=the course and the speed of the black box-water and its drift, respectively) and the current position data of the black box-water provide further valuable information for rescue teams. The identification data of the airplane or of the flight are helpful in determining the scope of the required rescue operation.

It has also turned out to be advantageous to equip a black box-water of the aircraft, which is intended for being detached from the aircraft already in the air, with one or several parachutes. As a result, the black box-water will float down to earth and land without sustaining any damage.

Furthermore, it is advantageous to equip the black boxes-water additionally with, in each case, one radar transmitter which ensures that the black boxes will be located quickly both at land and at sea. Finding the black boxes after emergency landings in difficult terrain (mountains, forests, deserts etc.) can thus be substantially simplified. Further technical implementations and advantages thereof are illustrated in further detail below on the basis of the figures.

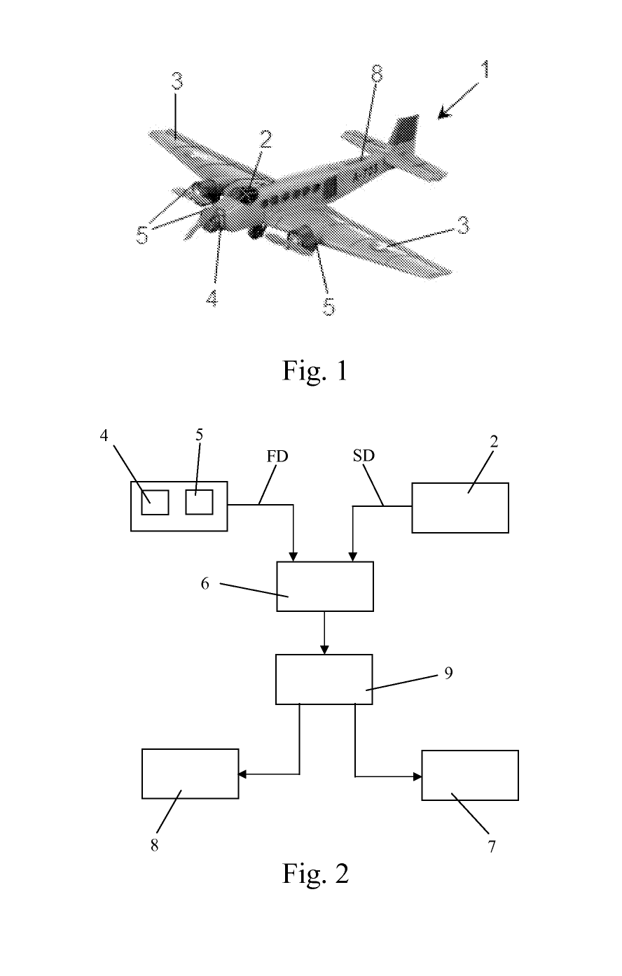

FIG. 1 shows an airplane according to a first exemplary embodiment, wherein a black box-water is installed on the upper side of the fuselage.

FIG. 2 shows a block diagram of the safety system provided in the airplane according to FIG. 1.

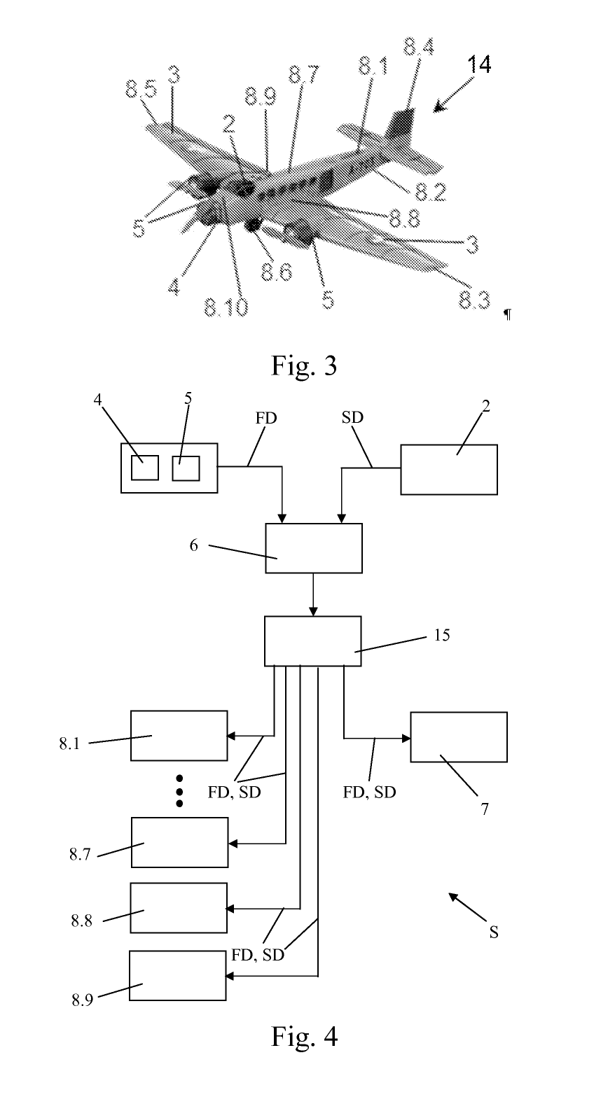

FIG. 3 shows an airplane according to a second exemplary embodiment, wherein a safety system comprising ten black boxes is provided.

FIG. 4 shows a block diagram of the safety system in the airplane according to FIG. 3.

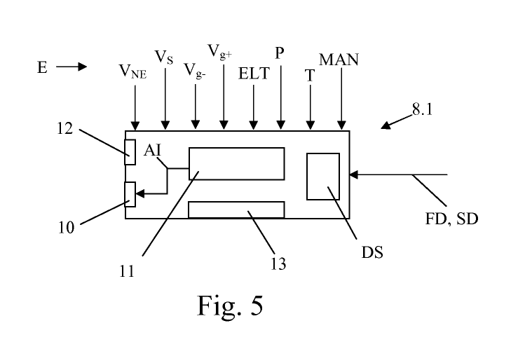

FIG. 5 shows a block diagram of a black box provided in the airplane according to FIG. 3.

FIG. 1 shows an airplane 1 comprising a cockpit 2 and wings 3. The airplane 1 possesses an airspeed indicator 4, one revolution counter 5 each per motor or engine, respectively, of the airplane 1 as well as a plurality of further measuring devices and sensors for physically measurable quantities the measured values of which assist the pilot in making decisions during the flight. While the pilot navigates the airplane 1, further measuring devices and sensors measure, for example, the actual position of the horizontal tail, the vertical tail and the landing flaps. These and other relevant data can be determined and delivered also directly by a board computer of the airplane 1. All these flight data FD which have been measured and are relevant for the flight are collected by a data collection device 6 of the airplane 1 and are converted into a data format suitable for storing the flight data FD, as is illustrated in FIG. 2. The data collection device 6 may be constituted by the board computer of the airplane 1 or a separate unit.

In flight, the communication of the pilot with the air traffic control as well as the communication of the pilot with the co-pilot are recorded, too, and transmitted as voice data SD to the data collection device 6. Thus, all relevant flight data FD and voice data SD concerning the flight are collected by the data collection device 6 and delivered to a black box-terra 7 of the airplane 1.

The black box-terra 7 has a data memory for storing the flight data FD and voice data SD. The black box-terra 7 is accommodated in the middle of the fuselage and is fixedly connected to the frame of the fuselage. The black box-terra 7 has an impact-proof and fireproof housing in order to protect the data memory in the black box-terra 7 against damage as well as possible during a crash of the airplane 1. The black box-terra 7 comes up to the current state of the art and the specification required for its approval as a black box and thereby withstands, for example, a temperature of 1,000° C. for at least 30 minutes and the ambient pressure prevailing in the sea at a depth of 5,000 metres. Furthermore, the black box-terra 7 comprises transmission means which are designed for transmitting an alarm signal after having been activated by a crash of the airplane 1. For locating the black box-terra above water, the alarm signal is transmitted at a frequency of 406 MHz, and for locating the black box-terra under water, the alarm signal is additionally transmitted at a frequency of 37.5 kHz. The device specifications of such black boxes approved for air traffic are determined in the device specifications “Electronics in Airplanes” in the document EUROCAE ED-112.

The safety system of the airplane 1 now comprises a further black box, namely a black box-water 8, which, on the upper side of the fuselage, is fitted into the streamlined shape of the fuselage, but is mounted so as to be essentially exposed toward the outside, apart from a lid. Furthermore, the safety system comprises a data splitter 9 which delivers flight data FD and voice data SD collected by the data collection device 6 both to the black box-terra 7 and to the black box-water 8. Thus, both black boxes 7 and 8 store identical data in parallel. The black box-water 8 now has a mechanical and electronic specification which, in comparison, is different from that of the black box-terra 7, which has substantial advantages in the present context.

The housing of the black box-water 8 is essentially designed for the case of the airplane 1 crashing into water or for the case of the airplane 1 ditching. For this purpose, the housing of the black box-water 8 forms a floating body which floats in the water and does not sink after having been separated from the airplane 1. With the black box-water 8, the release from the fuselage is effected by an underwater pressure sensor when a trigger criterion is provided, which underwater pressure sensor detaches or releases the black box-water 8 from the fuselage at a predetermined water pressure. Furthermore, the black box-water 8 can be disengaged manually by the aircrew already during the crash or also afterwards. In this case, a compression spring hurls the black box-water 8 a few metres away from the fuselage so that a fire in the fuselage or an explosion of the fuselage cannot harm the black box-water in any way. As soon as the black box-water 8 has been separated from the airplane, the transmission means of the black box-water 8 start to transmit at the transmitter frequency(-ies). Advantageously, the black box-water 8 uses a transmitter frequency which is already used in shipping for the emission of distress signals. For said transmitter frequency, a network of satellites orbiting the earth already exists, which satellites forward alarm signals transmitted at this transmitter frequency to rescue control centres.

By providing both the black box-terra 7 and the black box-water 8 in the airplane 1, the advantage is obtained that, in case of the airplane 1 crashing over land as well as over water, at least one of the black boxes 7 or 8 will survive the crash in all probability and will be found by a rescue team. Thus, it can be ensured that one of the two black boxes 7 or 8 can be located virtually independently of the crash site and hence the reasons for essentially all plane crashes can be cleared up.

Since all airplanes from a certain size already have to feature a black box-terra, it is advantageous to design the data splitter 9 and the black box-water 8 so as to be retrofittable in order to expand existing safety systems of airplanes by one or several black boxes-water 8.

A particular advantage of the invention results from the utilization of the existing infrastructure for the rescue of ships in distress for aircraft. However, the black box-terra and the black box-water according to the measures of the invention could also use other transmitter frequencies than the already established ones.

It may be mentioned that the black box-water can also be provided in other positions of the airplane. This can depend, for example, on the type of the airplane and the specific design thereof. For example, the black box-water could be installed in the airplane's empennage. A lid can cover the black box-water toward the outside in order to cover the opening in the airplane in which the black box-water is located and so as not to generate any turbulences on the surface of the airplane. The lid could be ejected or blasted from the airplane together with the black box-water.

It may be mentioned that it can be advantageous to design the floating body so as not to be inflatable but from a foamed material or a similar floatable material. In this way, it is avoided that the floating body can be cut open by a sharp part of the plane wreck.

It may be mentioned that the safety system can be used for any aircraft. However, it can be used particularly advantageously in airplanes, helicopters, hot-air balloons, zeppelins or also in other aircraft.

It may be mentioned that the respective trigger criterion and thus the type of activating the black box-water (whether triggered by a pressure sensor from a certain depth of water or whether triggered manually) makes no difference for the further functioning of the detached black box-water. Furthermore, it may be mentioned that it is advantageous to provide several black boxes-water in a flying object, as will be explained on the basis of the second exemplary embodiment.

FIG. 3 also shows an airplane 14 comprising a cockpit 2 and wings 3. The airplane 14 possesses an airspeed indicator 4, one revolution counter 5 each per motor of the airplane 14 as well as a plurality of further measuring devices and sensors for physically measurable quantities the measured values of which assist the pilot in making decisions during the flight. While the pilot navigates the airplane 14, further measuring devices and sensors measure, for example, the actual position of the horizontal tail, the vertical tail and the landing flaps. These and other relevant data can be determined and delivered also directly by a board computer of the airplane 14. All these flight data FD which have been measured and are relevant for the flight are collected by a data collection device 6 of the airplane 14 and are converted into a data format suitable for storing the flight data FD. The data collection device 6 may be constituted by the board computer of the airplane 14 or a separate unit.

In flight, the communication of the pilot with the air traffic control as well as the communication of the pilot with the co-pilot are recorded, too, and transmitted as voice data SD to the data collection device 6. Thus, all relevant flight data FD and voice data SD concerning the flight are collected by the data collection device 6 and delivered to a black box-terra 7 of the airplane 14.

The black box-terra 7 has a data memory for storing the flight data FD and voice data SD. The black box-terra 7 is accommodated in the middle of the fuselage and is fixedly connected to the frame of the fuselage. The black box-terra 7 has an impact-proof and fireproof housing in order to protect the data memory in the black box-terra 7 against damage as well as possible during a crash of the airplane 14. The black box-terra 7 comes up to the current state of the art and the specification required for its approval as a black box and thereby withstands, for example, a temperature of 1,000° C. for at least 30 minutes and the ambient pressure prevailing in the sea at a depth of 5,000 metres. Furthermore, the black box-terra 7 comprises transmission means which are designed for transmitting an alarm signal after having been activated by a crash of the airplane 14 (e.g., radar transmitter for homing).

For locating the black box-terra 7 above water, the alarm signal is transmitted at a frequency of 406 MHz, and for locating the black box-terra under water, the alarm signal is transmitted at a frequency of 37.5 kHz. The device specifications of such black boxes approved for air traffic are determined in the device specifications “Electronics in Airplanes” in the document EUROCAE ED-112.

However, nowadays, there are several emergency-call systems which transmit at various emergency-call frequencies partly on the basis of satellites, partly terrestrially, and are used either in aerotechnics or for shipping. A short summary of such emergency-call systems and emergency-call frequencies is provided below.

The frequency 121.5 MHz has been used in aerotechnics, but has resulted in a high number of false alarms, which is why it has been removed from official programs as an emergency-call frequency. Today, this frequency is used virtually exclusively as a so-called “homing function”.

The frequency 406 MHz is used by the Cospas-Sarsat system which transmits on Transas satellites. This satellite system covers the entire globe including north and south poles, but a delay of up to 6 hours may occur if just no satellite is responsive to the ground station.

The frequencies 1,644 MHz to 1,646 MHz are used by Inmarsat-E and have been reserved globally for emergencies by the ITU agency.

Inmarsat-E is a system of geostationary satellites which cover the globe up to the 80th latitude in four transmission ranges. Until recently, Inmarsat-E was used in shipping by so-called EPIRBs (Emergency position indicating radio beacon). Because of too little use for shipping, maintenance costs were too high, as a result of which the system was deactivated. Using the Inmarsat-E system for black boxes according to the invention would be very beneficial and would lead to sufficient use of the system for funding the maintenance costs.

Cospas-Sarsat is an emergency-call system likewise used for shipping. The satellites mainly consist in Russian, French and American Transas satellites.

Europe is in the process of building the Galileo SAT system which, in future, will also be applicable as an emergency-call system.

The safety system S of the airplane 14 now comprises nine further black boxes 8.1, 8.2 to 8.9 (black boxes-water) according to the invention, which are placed in different positions of the airplane 14. So as not to impair the streamlined shape of the airplane 14, the black boxes 8.1 to 8.9 are fitted into cavities of the surface of the airplane 14, each being flush with the surface of the airplane 14 via a lid. Furthermore, the safety system S comprises a data splitter 15 which delivers flight data FD and voice data SD collected by the data collection device 6 both to the black box-terra 7 and to the black boxes 8.1 to 8.9. Thus, all black boxes 7 and 8.1 to 8.9 store identical data in parallel. The black boxes 8.1 to 8.9 have a mechanical and electronic specification which, in comparison, is different from that of the black box-terra 7, which has substantial advantages in the present context.

The safety system S now comprises detachment means 10 which detach the black boxes 8.1 to 8.9 from the airplane 14 if a detachment criterion is provided. In FIG. 5, the black box 8.1 is illustrated as a block diagram, with the detachment means 10 being formed by a hook in the black box 8.1, which hook can be opened and closed electrically by a servomotor and is hooked into an eye in the cavity, which eye is fixedly provided on the airplane 14. In each black box 8.1 to 8.9, one data memory DS is provided for storing the relevant flight data FD and voice data SD. Furthermore, evaluation means 11 are provided in the black boxes 8.1 to 8.9, to which electric signals E concerning different detachment criteria can be supplied. Depending on which detachment criterion or which detachment criteria is/are relevant for the respective black box 8.1 to 8.9, the evaluation means 11 deliver a detachment information AI to the detachment means 10, whereupon the servomotor opens the hook and the black box 8.1 detaches itself from the airplane 14.

The following electric signals E are supplied to the black boxes 8.1 to 8.9 as possible detachment criteria:
A maximum speed signal V_{NE} (velocity never exceed) changes from a voltage of 2V to 5V if all airspeed indicators of the airplane 14 indicate in unison or at least predominantly that a speed has been exceeded which is absolutely too high for this model of aircraft and will virtually inevitably result in a crash.
A stalling air speed signal V_{S} changes from a voltage of 2V to 5V if all airspeed indicators of the airplane 14 indicate in unison or at least predominantly that a speed has been fallen short of which is too low for this model of aircraft and will virtually inevitably result in an interruption of the flow and a subsequent crash.
A maximum deceleration signal V_{g-} changes from a voltage of 2V to 5V if all deceleration sensors of the airplane 14 indicate in unison or at least predominantly that the airplane 14 is decelerated or braked, respectively, so strongly that this must result in a crash practically with certainty.
A maximum acceleration signal V_{g+} changes from a voltage of 2V to 5V if all acceleration sensors of the airplane 14 indicate in unison or at least predominantly that the airplane 14 is accelerated so strongly that this must result, practically with certainty, in damage to the supporting elements of the airplane 14 and ultimately a crash.
In airplanes, an emergency locator transmitter (ELT) is employed already today, the specification of which is dictated by the ICAO agency, which is why this is not discussed any further here. The ELT has integrated sensors which likewise serve for identifying a crash of an airplane. In case of a crash detected by the ELT, a crash signal ELT is delivered by the ELT as a crash criterion to the black box 8.1 to 8.9.
Pressure sensors which continuously measure the pressure in the airplane 14 and outside of the airplane 14 are located both in the airplane 14 and on the fuselage. If a maximum pressure is exceeded, a maximum pressure signal P is delivered as a detachment criterion to the black boxes 8.1 to 8.9.
Temperature sensors which continuously measure the temperature in the airplane 14 and outside of the airplane 14 are located both in the airplane 14 and on the fuselage. If a maximum temperature is exceeded, a maximum temperature signal T is delivered as a detachment criterion to the black boxes 8.1 to 8.9.
Furthermore, the aircrew can manually trigger the detachment of one or several black boxes by pressing a crash button, whereupon a manual signal MAN is delivered to the black boxes 8.1 to 8.9.

It may be mentioned that the previous definitions of, for example, the maximum speed and the stalling speed are to be understood to be exemplary. The respective aircraft manufacturer will be able to indicate an air speed which is critical for their airplane or a critical progression of air speed, which are usable as detachment criteria.

The evaluation means 11 of the individual black boxes 8.1 to 8.9 of the safety system S are now partially programmed differently and generate the detachment information AI, which will ultimately result in the hook being opened and the individual black boxes 8.1 to 8.9 being detached from the airplane 14, if different detachment criteria are provided. The evaluation means 11 of the black box 8.1 as well as the evaluation means of the other black boxes 8.2 to 8.9 monitor whether one or several of the trigger criteria is/are provided and, depending on the trigger criterion relevant for the respective black box 8.1 to 8.9, detach the respective black box 8.1 to 8.9 from the fuselage.

Furthermore, the safety system S of the airplane 14 comprises ejection means 12 which, according to this exemplary embodiment, are provided in the black boxes 8.1 to 8.9. The ejection means 12 are formed by a prestressed spring which pushes the black boxes 8.1 to 8.9 away from the airplane 14 by an elastic force as soon as the detachment means 10 detach, in each case, the individual black boxes 8.1 to 8.9 from the airplane 14. In this way, the advantage is obtained that the black boxes 8.1 to 8.9 are quickly hurled away from the immediate surrounding of the crashing or already crashed airplane 14.

Depending on which detachment criteria according to the programming of the evaluation means 11 will result in a detachment of the individual black boxes 8.1 to 8.9 from the airplane 14, the housing and the equipments of the black boxes 8.1 to 8.9 can be designed differently. The black box 8.1 is designed for being detached still in the air, before or during the crash of the airplane 14, which is why the black box 8.1 has a small parachute 13. As soon as the ejection means 12 have ejected the black box 8.1, a delay mechanism begins to operate which, 5 seconds after the ejection of the black box 8.1, releases the parachute 13, whereupon the parachute 13 can deploy freely. As a result of this time delay, the advantage is obtained that the black box 8.1 will reduce its flying speed because of the aerodynamic drag of the housing of the black box 8.1 and the parachute 13 can be opened without sustaining any damage. If, on the other hand, the delay time is set to be relatively long and the parachute 13 opens comparatively late, the risk exists that the black box 8.1 cannot be slowed down sufficiently before landing on the ground or in the water. Therefore, the delay times are set to be longer for some of the black boxes 8.1 to 8.9 and shorter for some of the black boxes 8.1 to 8.9 in order to increase the chance that as many of the black boxes 8.1 to 8.9 as possible will land without sustaining any damage. Furthermore, the preset delay time depends on the point in time and the altitude, respectively, for which the detachment from the airplane 14 is planned. Therefore, longer delay times have normally been programmed for black boxes 8.1 to 8.9 which are to be detached earlier.

On the other hand, the black box 8.2 is designed for being activated under water in case of the airplane 14 crashing into water. Therefore, the evaluation means 11 deliver the trigger information AI to the activation means 10 only if the maximum pressure signal P occurs. Since it may be assumed that, during the crash, large forces act upon the airplane 14, the housing of the black box 8.2 and the activation means 10 for the black box 8.2 are designed to have a particularly reliable and solid structure for this case. The housing of the black box 8.2 is designed to be self-floating and carries the weight of the entire black box 8.2, which is why the black box 8.2 will float on the water surface after the crash.

The black box 8.3 is a black box which is provided primarily for manual activation by the aircrew. Since, in all probability, the aircrew will be able to activate the crash botton only before the crash in an airplane 14 which is still in the air, this black box 8.3 is provided with a parachute and a comparatively long delay time of 10 seconds has been set.

On the other hand, the black box 8.5 is designed mainly for being detached upon the occurrence of the maximum deceleration signal V_{g-}. A maximum deceleration may typically occur in case of an impact of the airplane 14 on the surface of the earth or on water. Since, from a statistical point of view, in plane crashes, the first impact of an airplane often happens at the nose of the airplane, this black box 8.5 is provided in the horizontal tail of the airplane 14. Via the ejection means, the black box 8.5 is ejected upwards and the parachute opens already after a comparatively short delay time of one second, since, in this case, the airplane 14 has already slowed down relatively strongly and is located immediately near the ground or water.

The black boxes 8.1 to 8.9 have a separate GPS receiver which determines the current GPS position data and transmits them via the alarm signal to the satellite and from there to rescue teams.

Furthermore, it is particularly advantageous that the black boxes 8.1 to 8.9 transmit the alarm signal with the position data and the identification of the aircraft beginning with the time of the first contact with water, since, as a result of this, rescue teams will immediately know the time of the crash into the water. The position data of the black boxes at the time of the first contact with water, the position data determined since that point in time (=the course and the speed of the black boxes 8.1 to 8.9 and their drift, respectively) and the current position data of the black boxes provide further valuable information for the rescue teams. The identification data of the airplane or of the flight are helpful in determining the scope of the required rescue operation.

On the other hand, others of the black boxes 8.1 to 8.9 begin to emit the activation signal immediately after the detachment of the black box 8.1 to 8.9 from the airplane 14. Also, this information when and where, respectively, the respective black box 8.1 to 8.9 has been detached from the airplane 14 while still in the air assists rescue teams in determining the radius for their search for survivors and wreckage.

Advantageously, the black boxes 8.1 to 8.9 are now designed for transmitting the activation signal at all available emergency-call frequencies of the above-described emergency-call systems. Thus, on the one hand, the accuracy of one emergency-call system and, on the other hand, the permanent contact possibility of another one are utilized.

It may be mentioned that it can be advantageous to design the floating body so as not to be inflatable but from a foamed material or a similar floatable material. In this way, it is avoided that the floating body can be cut open by a sharp part of the plane wreck.

It may be mentioned that the ejection means can also be formed by a gas pressure spring or a pressurized cylinder filled with oil.

Since all airplanes from a certain size already have to feature a black box-terra, it is advantageous to design the data splitter 15 and the black boxes 8.1 to 8.9 so as to be retrofittable in order to expand existing safety systems of airplanes by the black boxes 8.1 to 8.9.

It may be mentioned that, in another safety system according to the invention, the black boxes 8.1 to 8.9 could also be activated in the air all at the same time. Furthermore, one of the black boxes 8.1 to 8.9 could also be intended for being detached in the air, but might do without a parachute because of an appropriate design of the housing (similar to a bomb). This black box 8.1 to 8.9 could then be detached at arbitrarily high speeds of the airplane 14. Based on the above disclosure of the invention, for a person skilled in the art, a plurality of further combinations of detachment criteria for different classes of frequently occurring types of airplane crashes are conceivable and thus also feasible within the scope of the invention.

It may be mentioned that the evaluation means for the signals E together with the activation mechanism of the detachment means might also be provided in the airplane. In this case, the board computer of the airplane would detach the individual black boxes 8.1 to 8.9 from the airplane depending on the existence of the respective detachment criteria. However, the above-described black boxes 8.1 to 8.9, which work self-sufficiently, have the advantage that they can detach themselves from the airplane independently and timely also in case of a failure of the board computer possibly caused by the crash.

It may be mentioned that, upon the occurrence of the manual trigger signal MAN or another trigger criterion, the black boxes 8.1 to 8.9 can be detached only if a certain maximum altitude has been fallen short of in order to prevent the black boxes 8.1 to 8.9 from landing at a too large distance from the airplane 14, which would impede the discovery of possible survivors.

It may be mentioned that a successful or an unsuccessful emergency landing can be used as a further detachment criterion, wherein the black boxes would be activated by a loss of pressure in the cabin and/or smoke development in the cabin and/or a failure of the oxygen system.

It may be mentioned that the voltage of 2V for the signal logic “0” and the voltage of 5V for the signal logic “1” are to be understood to be only exemplary and that other voltage values could also be used.

1.-15. (canceled)

16. A safety system for an aircraft for storing flight and voice data relevant for reconstructing crashes, comprising:
a data collection device which is connected to sensors of the aircraft and by means of which relevant flight data and voice data of the aircraft can be collected and stored by a black box-terra which is substantially inseparably attached to the aircraft, the black box-terra being accommodated in an impact-proof and fireproof housing;
a data splitter, wherein the flight data and voice data to be stored in the black box-terra can be delivered in parallel to at least one first and one second black box-water and that the black boxes-water are likewise designed for storing the collected flight and voice data, wherein the black boxes-water comprise:
a floating body or are designed to be self-floating;
detachment means in each black box-water which detach the black boxes-water from the aircraft immediately before, during or after a crash of the aircraft, upon an automatic or manual activation and upon the occurrence of different detachment criteria, whereupon the black boxes-water are designed to emit an alarm signal locatable by a satellite; and
evaluation means in each black box-water, to which electric signals concerning different detachment criteria can be supplied and which, depending on which detachment criterion or which detachment criteria is/are relevant for the respective black box-water, are designed to deliver a detachment information to the detachment means for detaching the black boxes-water at different times.

17. A safety system according to claim 16, wherein the detachment means are designed to detach one or several of the black boxes-water upon the occurrence of one or several of the following detachment criteria:
exceedance of a maximum speed (V_{NE});
falling short of a stalling air speed (V_{S});
exceedance of a maximum deceleration (V_{g-});
exceedance of a maximum acceleration (V_{g+});
response of an emergency locator transmitter (ELT);
exceedance of a maximum pressure (P);
exceedance of a maximum temperature (T); and
manual activation (MAN).

18. A safety system according to claim 16, further comprising, ejection means which are designed to eject, after the detachment of the detachment means, one or several of the black boxes-water with one or several of the following means:
a mechanical element, in particular a spring,
a gaseous material, in particular compressed air,
a liquid material, in particular oil.

19. A safety system according to claim 16, wherein the at least one black box-water is in a cavity on the fuselage of the aircraft—in particular on the upper side of the fuselage—and, in case of the aircraft crashing, detaches itself from the fuselage when dipping into the water.

20. A safety system according to claim 16, further comprising a mechanical lock which can be activated after a successful ditching and for service operations, in order to separate the black box-water from the fuselage of the aircraft.

21. A safety system according to claim 16, wherein the floating body is designed to prevent the black box-water from sinking into the water.

22. A safety system according to claim 16, wherein the black box-water further comprises, a GPS receiver for detecting the current GPS position and the black box-water is designed as part of the alarm signal for delivering the current GPS position.

23. A safety system according to claim 22, wherein one or several of the black boxes-water emit(s) the alarm signal at one or several of the standardized emergency frequencies, in particular 121.5 MHz, 406 MHz, 1.644 MHz to 1.646 MHz.

24. A safety system according to claim 16, wherein the black box-terra is particularly robust because of an at least impact-proof and fireproof design of its housing in case of the aircraft crashing over land and the black box-water is particularly robust because of an at least impact-proof and floatable design of its housing in case of the aircraft crashing over water and at least one of the two black boxes is designed to emit the alarm signal depending on the area of the crash.

25. A safety system according to claim 16, wherein, in an aircraft containing a black box-terra, one black box-water is retrofittable.

26. A safety system according to claim 16, the black box-water is constituted by an EPIRB buoy as part of a satellite-based global sea rescue system provided for maritime shipping.

27. A safety system according to claim 16, wherein at least one or more of the following data are transmitted in the alarm signal:
time of the first contact with water
GPS position data at the time of the first contact with water
current GPS position data
course of the black box-water
speed of the black box-water
identification data of the aircraft and of the flight, respectively

28. A safety system according to claim 16, wherein the detachment means are designed for a time-delayed detachment of at least one of the black boxes-water.

29. A safety system according to claim 16, wherein the black box-water further comprises, a radar transmitter for terrestrial radar ranging.

30. A safety system according to claim 16, wherein the black boxes-water, intended for being detached in the air, are designed with a housing similar to a bomb, without a parachute.

32. An aircraft, comprising, a safety system for storing flight and voice data relevant for reconstructing crashes, the safety system comprising:
a data collection device which is connected to sensors of the aircraft and by means of which relevant flight data and voice data of the aircraft can be collected and stored by a black box-terra which is substantially inseparably attached to the aircraft, the black box-terra being accommodated in an impact-proof and fireproof housing;
a data splitter, wherein the flight data and voice data to be stored in the black box-terra can be delivered in parallel to at least one first and one second black box-water and that the black boxes-water are likewise designed for storing the collected flight and voice data, wherein the black boxes-water comprise:
a floating body or are designed to be self-floating;
detachment means in each black box-water which detach the black boxes-water from the aircraft immediately before, during or after a crash of the aircraft, upon an automatic or manual activation and upon the occurrence of different detachment criteria, whereupon the black boxes-water are designed to emit an alarm signal locatable by a satellite; and
evaluation means in each black box-water, to which electric signals concerning different detachment criteria can be supplied and which, depending on which detachment criterion or which detachment criteria is/are relevant for the respective black box-water, are designed to deliver a detachment information to the detachment means for detaching the black boxes-water at different times.
